(19) United States
(12) Patent Application Publication
(10) Pub. No.: US 2013/0302532 A1
(43) Pub. Date: Nov. 14, 2013

(54) METHOD AND APPARATUS FOR MANUFACTURING PERPENDICULAR MAGNETIC RECORDING MEDIUM

(71) Applicant: IZA CORPORATION, Tokyo (JP)

(72) Inventor: Noel Abarra, Fuchu-shi (JP)

(73) Assignee: IZA CORPORATION, Tokyo (JP)

(21) Appl. No.: 13/890,628

(22) Filed: May 9, 2013

(30) Foreign Application Priority Data
May 9, 2012 (JP) 2012-107774

(51) Int. Cl. G11B 5/84

(52) U.S. Cl. CPC G11B 5/84
USPC 427/543; 118/620

(57) ABSTRACT

A method and an apparatus for manufacturing a perpendicular magnetic recording medium are provided which can easily demagnetize a magnetic layer with a high coercivity. The method includes: forming a magnetic layer on a substrate; applying magnetic fields parallel to the surface of the magnetic layer having a coercivity reduced below the intensity of said magnetic field by heating of the magnetic layer; and removing said magnetic field.

### BACKGROUND OF THE INVENTION

1. Field of the Invention

The present invention relates to a method and an apparatus for manufacturing a magnetic recording medium having a magnetic layer with a high coercivity, and more specifically, a magnetic recording medium having a function of demagnetizing a magnetic layer.

2. Description of the Related Art

Magnetic Hard Disk Drives (HDDs) typically include a magnetic disk medium and a magnetic head. In general, the magnetic disk medium is a perpendicular magnetic recording medium having high coercivity polycrystalline magnetic films with perpendicular magnetic anisotropy on a magnetic disk surface. The magnetic head includes a magnetoresistive reader and a high magnetic moment writer. Data is written in the magnetic disk medium, and data recorded in the disk medium is read.

A perpendicular magnetic recording medium includes a substrate, a thin film layer having non-magnetic and magnetic layers, an overcoat typically made of carbon, and a lubricant layer.

The perpendicular magnetic recording medium has a continuous surface having no micro fabricated pattern, but is formed of grains having an average diameter of smaller than 10 nm. The thin film has magnetic grains grown in a columnar shape, and has a single magnetic moment such that the respective magnetic grains are switched up or down and rotated relative to the disk surface.

The perpendicular magnetic recording medium is formed by a manufacturing device including a plurality of process chambers for heating a substrate, and forming a film on the substrate. A plurality of magnetic layers are employed with the layer closest to the substrate and typically having the highest magnetic anisotropy.

The layer formed successively to the magnetic layer tends to have lower magnetic anisotropy energies but higher saturated magnetization in order to improve the writability while maintaining thermal stability.

The magnetic layer typically has a room-temperature coercivity of 5 kOe and magnetic anisotropy strength of smaller than 10 kOe. Advancement of the high-densification of HDDs brings about a disadvantage that magnetically recorded data is erased by heat generated around such data. In order to suppress such thermal fluctuation, a further higher coercivity is required for perpendicular magnetic recording media. In order to enable a writing on a medium having a high coercivity, however, it is necessary to increase the magnetic field available to the magnetic head, but the available magnetic fields to the magnetic head are limited so far. Hence, energy assisted writing is being considered as a path to higher areal density.

In applying the energy assisted writing, higher magnetic anisotropy granular materials may be employed and grains are made smaller to realize smaller bit areas.

Media with room temperature coercivities of larger than 10 kOe are being currently investigated. The moment of the high coercivity media could be switched by modest magnetic writing head assisted by local heating or microwave energy.

Candidate materials are alloys, such as Co—Pt, Fe—Co—Pt, and Fe—Pt, and multilayers, such as Co/Pt, and Fe/Pt (inexpensive Pd is also being considered instead of Pt). Current perpendicular magnetic recording media manufacturing devices include, for example, 24 a plurality of vacuum chambers connected together. A disk carrier transports a substrate from chamber to chamber for heating and deposition.

Since a perpendicular magnetic recording medium includes a multilayer film, most chambers are for magnetron sputtering. That is, one or two chambers are dedicated for overcoat deposition, while equal to or greater than one other chamber is for heating.

Two chambers are employed for disk loading and unloading, and another chamber is employed for substrate cooling before overcoat deposition. Heating, cooling, and deposition are typically performed on both surfaces of a substrate. The chamber holds two targets with respective target surfaces facing with each other, and the substrate is loaded between the two targets. A magnet assembly for magnetron sputtering is provided at the rear face of the target and the exterior of the chamber in a freely rotatable manner.

Energy assisted magnetic recording media are not currently being manufactured in high volume, but the manufacturing thereof is not considered to be significantly different from that of conventional perpendicular magnetic recording medium except for more involved heating and cooling requirements.

Whereas current perpendicular magnetic recording media are being deposited at a temperature of equal to or lower than 200° C., the candidate materials and multilayer films are preferably formed at a substrate temperature of equal to or higher than 400° C. in order to introduce chemical ordering that gives rise to high magnetic anisotropy.

Rapid cooling is performed for optimization of deposition temperature of subsequent formation of lower coercivity magnetic alloys and the overcoat. Large area magnetic domains are observed on the perpendicular magnetic recording medium after deposition by sputtering. The large magnetic domains with the same magnetization direction in the medium adversely affect the reading or writing bits. In order to divide the magnetic domains in the large areas to downsize the magnetic domain, an additional demagnetization process is performed before read-write performance testing or drive assembly.

For example, JP 2011-86342 A discloses a magnetic recording medium initialization technique of applying static magnetic fields in the vertical direction to the axis of easy magnetization of the magnetic recording medium, and of applying high-frequency magnetic fields, thereby erasing the magnetism of the magnetic recording medium.

Moreover, JP 2004-326960 A discloses a demagnetization method and an apparatus for a perpendicular magnetic recording disk which move, on a disk surface, a pair of magnetic poles generating magnetic fields in the vertical direction transmissive to the surface of the perpendicular magnetic recording disk with the disk surface being held between the pair of magnetic poles, and which erase recording signals and/or noises on the disk surface.

According to the conventional demagnetization apparatuses, however, no microwave is transmitted unless the magnetic recording medium is disposed near the apparatus. Hence, it is difficult to perform the demagnetization process while controlling a distance between the magnetic recording medium and the apparatus. Moreover, there are other disadvantages such that the apparatus becomes complex and the costs increase.

The present invention has been made in view of the above-explained disadvantages, and it is an object of the present invention to provide a method and an apparatus for manufacturing a perpendicular magnetic recording medium which can easily demagnetize a magnetic layer with a high coercivity.

### SUMMARY OF THE INVENTION

According to a first aspect of the present invention, there is provided a method of manufacturing a demagnetized perpendicular magnetic recording medium that includes: forming a magnetic layer on a substrate; applying a magnetic field parallel to a surface of the magnetic layer having a coercivity reduced below the intensity of said magnetic field by heating of the magnetic layer; and removing the magnetic field.

According to a second aspect of the present invention, there is provided an apparatus for manufacturing a perpendicular magnetic recording medium, the apparatus including: a heating chamber that heats a substrate; a first-magnetic-layer formation chamber that forms a first magnetic layer on the substrate; and a magnetic field generator that applies, to the substrate on which the first magnetic layer is formed, a magnetic field parallel to a surface of the substrate.

According to the present invention, demagnetization is performed with the substrate temperature being high, i.e., the coercivity of the first magnetic layer being reduced by heating the substrate. Hence, demagnetization is enabled by applying a further smaller magnetic field, thereby facilitating demagnetization of the magnetic layer with a high coercivity.

### BRIEF DESCRIPTION OF THE DRAWINGS

FIG. 1 is an exemplary diagram illustrating a structure of a perpendicular magnetic recording medium;

FIG. 2 is a graph illustrating a substrate temperature transition when a substrate of 500° C. is cooled with time by heat irradiation in a vacuum chamber and a change in the coercivity at this time;

FIG. 3 is a plan view exemplary illustrating a structure of a manufacturing apparatus of a perpendicular magnetic recording medium according to a first embodiment;

FIG. 4 is a partial vertical cross-sectional view illustrating a structure of the perpendicular-magnetic-recording-medium manufacturing apparatus according to the first embodiment;

FIG. 5 is a flowchart illustrating a process flow by the perpendicular-magnetic-recording-medium manufacturing apparatus according to the first embodiment;

FIG. 6 is a partial vertical cross-sectional view illustrating a modified example of the perpendicular-magnetic-recording-medium manufacturing apparatus of the first embodiment;

FIG. 7 is a horizontal cross-sectional view illustrating a structure of a magnetic field generator according to another modified example of the perpendicular-magnetic-recording-medium manufacturing apparatus of the first embodiment;

FIG. 8 is a vertical cross-sectional view illustrating a structure of a magnetic field generator according to another modified example of the perpendicular-magnetic-recording-medium manufacturing apparatus of the first embodiment;

FIG. 9 is a map indicating a magnetic field direction in a Y-Z plane of the magnetic field generator and a magnetic field intensity according to another modified example of the perpendicular-magnetic-recording-medium manufacturing apparatus of the first embodiment;

FIG. 10 is a plan view exemplarily illustrating a structure of a manufacturing apparatus of a perpendicular magnetic recording medium according to a second embodiment;

FIG. 11 is a partial vertical cross-sectional view illustrating a structure of the perpendicular-magnetic-recording-medium manufacturing apparatus according to the second embodiment;

FIG. 12 is a flowchart illustrating a process flow by the perpendicular-magnetic-recording-medium manufacturing apparatus according to the second embodiment;

FIG. 13 is a partial vertical cross-sectional view illustrating a modified example of the perpendicular-magnetic-recording-medium manufacturing apparatus according to the second embodiment;

FIG. 14 is a flowchart illustrating a process flow according to a modified example of the perpendicular-magnetic-recording-medium manufacturing apparatus of the second embodiment;

FIG. 15 is a partial vertical cross-sectional view illustrating a structure of a manufacturing apparatus of a perpendicular magnetic recording medium according to a third embodiment;

FIG. 16 is a horizontal cross-sectional view illustrating a structure of a magnetic field generator of the perpendicular-magnetic-recording-medium manufacturing apparatus according to the third embodiment;

FIGS. 17A and 17B are magnetic field maps of the magnetic field generator of the perpendicular-magnetic-recording-medium manufacturing apparatus according to the third embodiment, and FIG. 17A is a magnetic field map parallel to a substrate, while FIG. 17B is a magnetic field map perpendicular to the substrate; and

FIG. 18 is a flowchart illustrating a process flow by the perpendicular-magnetic-recording-medium manufacturing apparatus according to the third embodiment.

### DETAILED DESCRIPTION OF THE PREFERRED EMBODIMENTS

Embodiments of the present invention will be explained in detail with reference to the accompanying drawings.

### (1) Thermally Assisted Magnetic Recording Medium

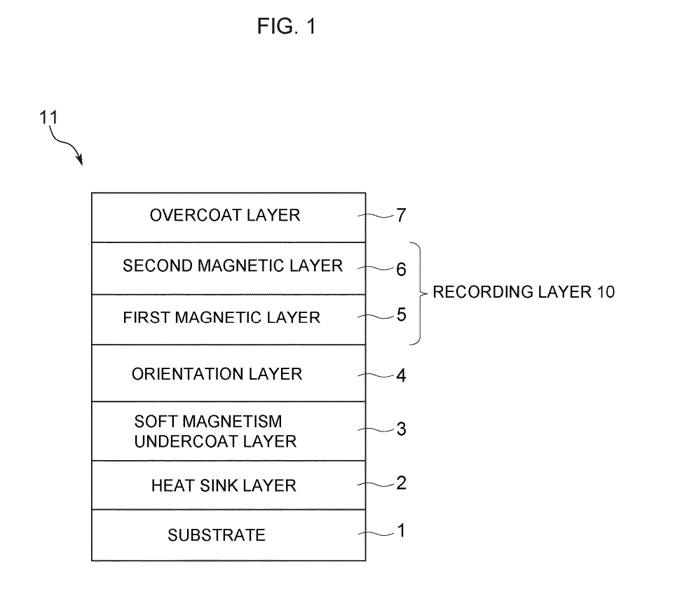

First, an explanation will be given of an example magnetic recording medium manufactured by a method and an apparatus for manufacturing a magnetic recording medium according to an embodiment of the present invention. A perpendicular magnetic recording medium 11 illustrated in FIG. 1 has a heat sink layer 2, a soft magnetism undercoat layer 3, an orientation layer 4, a recording layer 10, and an overcoat layer 7 laminated on a substrate 1 in this order. The recording layer 10 includes a first magnetic layer 5 and a second magnetic layer 6 as magnetic layers. This figure illustrates a case in which a multilayer film is formed on only one side of the substrate for facilitating the explanation, but multilayer films are formed on both sides of the substrate in practice.

The substrate 1 can be formed of glass typically used, or a non-magnetic materials, such as ceramics, and Si. According to this example, the material of the first magnetic layer 5 applied is FePt or CoPt, and thus the first magnetic layer 5 has the maximum coercivity in the magnetic recording medium. Moreover, the material of the second magnetic layer 6 applied is the same material as that of the first magnetic layer 5, such as FePt or CoPt, or a material other than FePt and CoPt and having a smaller coercivity. When the materials of the first magnetic layer 5 and the second magnetic layer 6 are the same, depending on the temperature at the time of deposition of each layer, the regularity becomes different, and the coercivity becomes also different. Moreover, even if the materials of the first magnetic layer 5 and the second magnetic layer 6 are the same, when the composition ratio differs, the coercivity becomes different. In any cases, the first magnetic layer 5 has the maximum coercivity. The orientation layer 4 is also called a seed layer, and is formed as an undercoat layer that causes the axis of easy magnetization of the first magnetic layer 5 formed successively to be oriented in a certain direction.

The perpendicular magnetic recording medium 11 illustrated in this figure is merely an example of the magnetic recording medium manufactured by the method and the apparatus for manufacturing the magnetic recording medium according to an embodiment of the present invention, and the structure and the applied materials are not limited to this example.

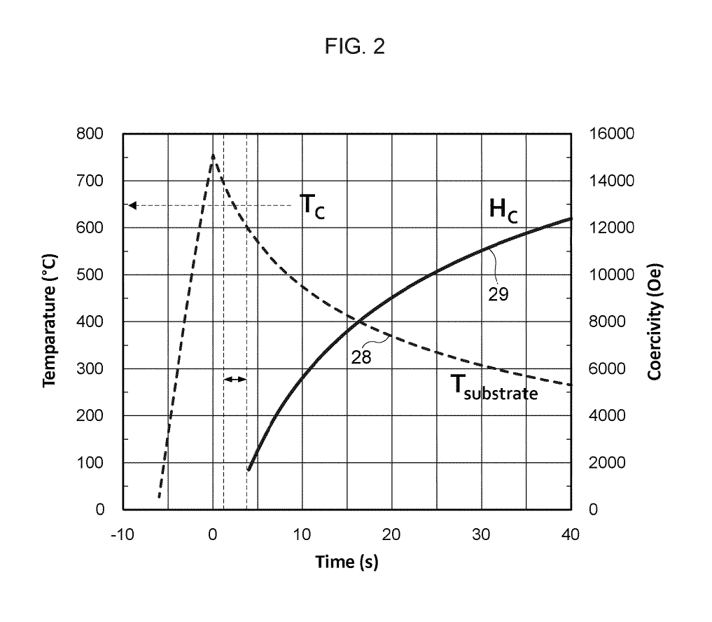

Next, a demagnetizing method of the first magnetic layer having a large coercivity that is, for example, 20 kOe at a room temperature will be discussed. When the first magnetic layer 5 is formed, in order to enhance the magnetic anisotropy, the substrate 1 is typically heated to a temperature equal to or higher than 400° C. or so. FIG. 2 illustrates a substrate temperature transition when the substrate 1 of 750° C. is cooled with time in a vacuum chamber by heat irradiation, and a coercivity at this time. It becomes clear from this figure that the substrate temperature decreases as time advances (reference numeral 28 in the figure), and the coercivity of the first magnetic layer 5 sharply increases (reference numeral 29 in the figure) as the substrate temperature decreases. In order to demagnetize the first magnetic layer 5 with a high coercivity at a room temperature, it is necessary to apply a large magnetic field across the area corresponding to a surface area of the substrate 1. Accordingly, it is difficult to demagnetize the first magnetic layer 5 at a room temperature.

The inventor of the present invention found that a magnetic field necessary for a demagnetization can be reduced by maintaining the temperature of the substrate 1 to a temperature near the Curie temperature after the first magnetic layer 5 is formed, and by performing demagnetization with the coercivity of the first magnetic layer 5 being small.

According to a technique of heating the completed perpendicular magnetic recording medium 11 for demagnetization that is a demagnetization technique of heating the substrate 1, an expensive vacuum environment becomes necessary to suppress a deterioration of the film. Moreover, according to a technique of performing demagnetization using the data writer of an energy assisted magnetic head, it takes a time and is not practical.

The present invention addresses the above-explained disadvantages by performing demagnetization during a process of forming a thin film, not by performing demagnetization after the perpendicular magnetic recording medium 11 completes or by performing demagnetization after the perpendicular magnetic recording medium 11 is unloaded from a magnetic-recording-medium manufacturing apparatus.

A demagnetization process by magnetic field application of the present invention is performed at a high temperature under a vacuum or inactive gas atmosphere. The term “vacuum atmosphere” means a depressurized condition more than atmospheric pressure, and more preferably, a condition having a pressure of equal to or lower than 1×10⁻¹ Pa. Moreover, the inactive gas atmosphere means an atmosphere of inactive gas like argon which does not affect the film characteristics.

Since the temperature of the substrate 1 sharply decreases from a high temperature condition, the timing of the demagnetization process is strictly important in order to avoid the increase of the coercivity due to cooling. According to an embodiment, right after the magnetic layer having the maximum magnetic anisotropy is deposited, in-plane magnetic fields parallel to the surface of the substrate are applied at a temperature of equal to or lower than the Curie temperature of the magnetic layer with the substrate 1 being subjected to a sufficient temperature rise and remaining still. This temperature is different due to magnetic materials, however, it is preferable that this temperature should be equal to or higher than a temperature that is lower than the Curie temperature of the magnetic layer by 200° C., more preferably, equal to or higher than a temperature that is lower than the Curie temperature by 100° C. When, for example, in-plane magnetic fields of 5000 Oe or so are applied to a film having the coercivity of 2500 Oe at a temperature of 450° C. or so, demagnetization can be carried out sufficiently.

A magnetic domain structure having the maximum magnetic anisotropy is transferred on another magnetic layer formed on the demagnetized magnetic layer. The perpendicular magnetic recording medium 11 unloaded from the manufacturing apparatus through the above-explained processes is demagnetized with a desired magnetic condition requisite for an electrical inspection and an integration of a hard disk drive.

### (2) First Embodiment

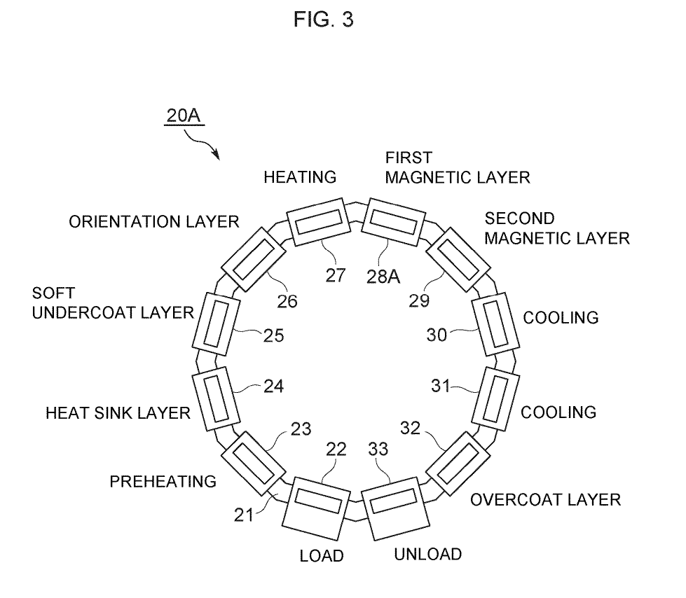

Next, an explanation will be given of a manufacturing apparatus 20A of the perpendicular magnetic recording medium 11 (hereinafter, referred to as the “manufacturing apparatus”) according to the first embodiment of the present invention. The manufacturing apparatus 20A illustrated in FIG. 3 includes a transfer system 21, a load lock chamber 22, a preheating chamber 23, a heat-sink-layer formation chamber 24, a soft-magnetism-undercoat-layer formation chamber 25, an orientation-layer formation chamber 26, a heating chamber 27, a first-magnetic-layer formation chamber 28A, a second-magnetic-layer formation chamber 29, a first cooling chamber 30, a second cooling chamber 31, an overcoat-layer formation chamber 32, and an unload chamber 33. The manufacturing apparatus 20A is capable of manufacturing the perpendicular magnetic recording medium 11 having multilayer films on both sides of the substrate 1. The respective chambers are disposed annularly, are connected with each other through an openable/closable gate valve (unillustrated), and perform processes, such as heating and deposition, on both sides of the substrate 1 simultaneously.

The manufacturing apparatus 20A includes an unillustrated controller that comprehensively controls the transfer system 21 and the respective chambers. The controller reads a basic program and various control programs stored in advance, and controls the whole manufacturing apparatus 20A in accordance with those programs. For example, the controller controls an operation of robots of the load lock chamber 22 and the unload chamber 33, a transporting operation of the transfer system 21, power on/off to a target provided in the chamber, an introduction operation of a process gas, an exhaust operation of exhaust means, a rotation operation of a magnet unit, and a current on/off to an electric magnet.

The load lock chamber 22 includes a robot (unillustrated) that mounts the substrate 1 on the transfer system 21. The transfer system 21 is formed so as to be capable of transporting the substrate 1 to each chamber successively while holding the substrate 1 vertically. The preheating chamber 23 is provided with a plurality of irradiation heaters facing with both sides of the substrate 1. The first cooling chamber 30 and the second cooling chamber 31 cool the substrate 1 to form the overcoat layer 7. The unload chamber 33 includes a robot (unillustrated) that conveys the completed perpendicular magnetic recording medium 11 to the exterior of the manufacturing apparatus 20A. It is not illustrated in the figure but each chamber is provided with a gas inlet and a vacuum pump which discharge air in the chamber and which perform venting.

First, the controller causes the load lock chamber 22 to receive the substrate 1, and to mount the substrate 1 on the transfer system 21. Next, the controller causes the transfer system 21 to transport the substrate 1 to the preheating chamber 23. The controller causes the preheating chamber 23 to heat the substrate 1 to 150° C. or so.

Next, the controller transports the substrate 1 to the heat-sink-layer formation chamber 24. The controller causes the heat-sink-layer formation chamber 24 to form the heat sink layer 2 on the substrate 1. Subsequently, the controller causes the transfer system 21 to transport the substrate 1 to the soft-magnetism-undercoat-layer formation chamber 25. The controller causes the soft-magnetism-undercoat-layer formation chamber 25 to form the soft magnetism undercoat layer 3 on the heat sink layer 2 formed on the substrate 1. Next, the controller causes the transfer system 21 to transport the substrate 1 to the orientation-layer formation chamber 26. The controller causes the orientation-layer formation chamber 26 to form the orientation layer 4 on the soft magnetism undercoat layer 3 formed on the substrate 1. The heat sink layer 2, the soft magnetism undercoat layer 3, and the orientation layer 4 are all deposited by normal sputtering. In the case of this embodiment, a high magnetic anisotropy material applicable is, for example, Fe—Pt or Co—Pt, and it is preferable that the perpendicular magnetic anisotropy energy should be Ku≧5×10⁶ erg/cc, more preferably, Ku≧10⁷ erg/cc.

Next, the controller causes the transfer system 21 to transport the substrate 1 to the heating chamber 27. The controller causes the heating chamber 27 to heat the substrate 1 to a temperature of for example, equal to or higher than 400° C. When Fe—Pt or Co—Pt, etc., is applied as the high magnetic anisotropy material, it is necessary to perform deposition at a high temperature of equal to or higher than 400° C. in order to enhance the magnetic anisotropy. The heating chamber 27 heats the substrate 1 in advance for preparing a high temperature deposition of the first magnetic layer 5. When the heating temperature is too high, the substrate 1 formed of glass, etc., is plastically deformed, and the substrate 1 is dropped from the transfer system 21. Hence, it is preferable that the heating chamber 27 should perform heating at a temperature that does not cause a plastic deformation of the substrate 1. However, technical innovation for enhancing the heat resistance of the substrate 1 is advancing recently, and it is expected that the heating temperature will be about 700° C. in future.

The substrate 1 heated to a temperature of equal to or lower than 700° C. has a large surface area and a small thermal capacity, and is cooled soon by heat irradiation (see FIG. 2: 0 second to 5 seconds). Hence, it is preferable that the heating chamber 27 should be provided right before the first-magnetic-layer formation chamber 28A and the second-magnetic-layer formation chamber 29 (an upstream side in the transporting direction).

Subsequently, the controller causes the transfer system 21 to transport the substrate 1 to the first-magnetic-layer formation chamber 28A and the second-magnetic-layer formation chamber 29 in sequence, and the first magnetic layer 5 is formed on the orientation layer 4 formed on the substrate 1, and the second magnetic layer 6 is formed on the first magnetic layer 5 in sequence.

Next, the controller causes the transfer system 21 to transport the substrate 1 to the first cooling chamber 30 and the second cooling chamber 31. In order to optimize the deposition temperature of the overcoat layer 7, the substrate 1 is cooled to a temperature of equal to or lower than 300° C. Moreover, it is necessary to sufficiently cool the perpendicular magnetic recording medium 11 before unloaded from the manufacturing apparatus 20A in order to suppress a deterioration of the multilayer films by ambient gas.

Subsequently, the controller causes the transfer system 21 to transport the substrate 1 to the overcoat-layer formation chamber 32. The controller causes the overcoat-layer formation chamber 32 to form high-density diamond-like carbon on the second magnetic layer formed on the substrate 1 by CVD (Chemical Vapor Deposition). The surface of the overcoat layer 7 is revealed to nitrogen gas under a plasma atmosphere in the overcoat-layer formation chamber 32, thereby being further cleaned in order to enhance the bonding characteristic of a following lubricant layer.

The throughput of the manufacturing apparatus 20A is controlled based on the transporting speed and the process procedure with the maximum duration time. According to this embodiment, in order to form a thick film of equal to or greater than 30 nm, the processes are carried out through a plurality of deposition chambers in order to reduce the process time in each chamber. In order to improve the throughput and to cope with the perpendicular magnetic recording medium 11 having a structure complicated due to a requirement for a high level electrical performance, the current manufacturing apparatus 20A has equal to or greater than 20 chambers.

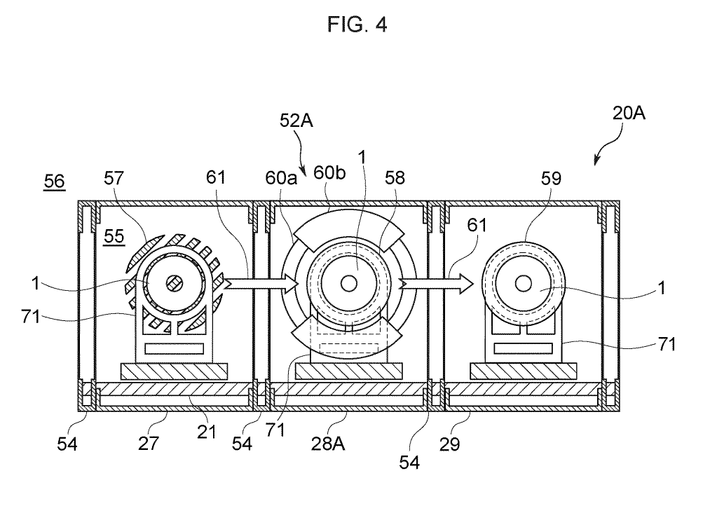

FIG. 4 is a vertical cross-sectional view illustrating the heating chamber 27, the first-magnetic-layer formation chamber 28A, and the second-magnetic-layer formation chamber 29 that are some chambers constructing the manufacturing apparatus 20A. The respective chambers are partitioned by partition walls 54. In practice, the partition wall 54 is provided with an unillustrated gate valve so as to prevent the process gas from going in and out between the respective chambers.

The heating chamber 27 includes a plurality of irradiation heaters 57 provided at both sides of the substrate 1 with the substrate 1 being present between the irradiation heaters. The substrate 1 is held by a carrier 71 in a vertical direction. The carrier 71 is provided in a manner movable by the transfer system 21 along the transporting direction.

The first-magnetic-layer formation chamber 28A has a first target 58 and a magnetic field generator 52A provided at both sides of the substrate 1 with the substrate 1 being present between the first target and the magnetic field generator. The magnetic field generator 52A includes an electric magnet having a yoke 60a and a coil 60b wound around the yoke 60a. The coil 60b is electrically connected with an unillustrated power source, and generates in-plane magnetic fields parallel to the surface of the substrate 1 around the yoke 60a by supplied power.

The second-magnetic-layer formation chamber 29 has second targets 59 provided at both sides of the substrate 1 with the substrate 1 being present between those targets.

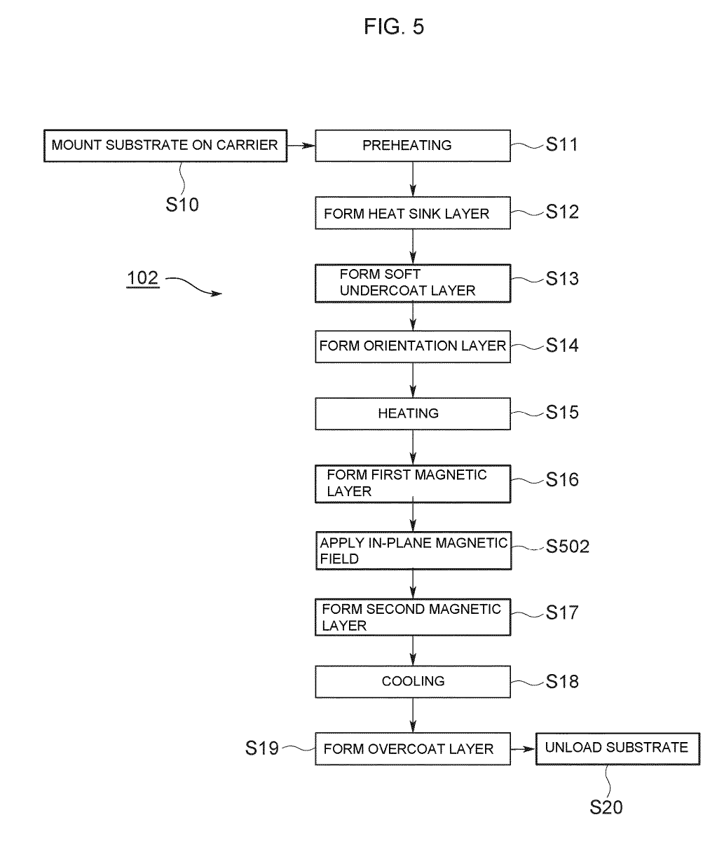

Next, with reference to FIG. 5, an explanation will be given of a process flow 102 by the manufacturing apparatus 20A according to this embodiment.

First, the controller causes the load lock chamber 22 to receive the substrate 1 in step S10, mounts the substrate 1 on the transfer system 21, and progresses the process to step S11.

The controller heats the substrate 1 to 150° C. or so in the step S11, and the progresses the process to step S12. The controller forms the heat sink layer 2 on the substrate 1 in the step S12, and the progresses the process to step S13. The controller forms in the step S13 a soft magnetism undercoat layer 3 on the heat sink layer 2 formed on the substrate 1, and progresses the process to step S14.

The controller forms in the step S14 the orientation layer 4 on the soft magnetism undercoat layer 3 formed on the substrate 1, and progresses the process to step S15.

The controller heats the substrate 1 to a temperature of equal to or higher than 400° C. in the step S15, and progresses the process to step S16. The controller forms in the step S16 the first magnetic layer 5 on the orientation layer 4 formed on the substrate 1, and progresses the process to step S502.

The controller applies in-plane magnetic fields to the substrate 1 in the step S502. In this case, the substrate 1 heated in the step S15 is cooled through deposition of the first magnetic layer 5 and the transporting process by heat irradiation, but the magnetic fields are applied before the coercivity of the first magnetic layer 5 becomes high due to the temperature drop of the substrate. Accordingly, the first magnetic layer 5 can be demagnetized formed on the substrate 1 by a smaller magnetic field, and thus minute magnetic domains are formed on the first magnetic layer 5. It is preferable that the substrate temperature at the time of demagnetization should be a temperature as close to the Curie temperature as possible from the standpoint of reducing the coercivity of the first magnetic layer 5. It is, however, necessary that such a temperature should be equal to or lower than a temperature that does not cause the substrate 1 to be plastically deformed as explained above.

According to this embodiment, the magnetic field generator 52A is constructed by an electric magnet, and thus the magnetic fields can be applied and cut off by turning on/off the power supplied to the coil 60b. Accordingly, although the manufacturing apparatus 20A is provided with the magnetic field generator 52A in the first-magnetic-layer formation chamber 28A that is an interior of the process environment, by cutting off the magnetic fields while the first magnetic layer 5 is being deposited, it becomes possible to prevent the magnetic field generator 52A from affecting plasma. The interior of the process environment means an interior of the environment where the magnetic fields generated by the magnetic field generator 52A affect the sputtering during deposition. Next, the controller cuts off the magnetic fields, and progresses the process to step S17.

The controller forms in the step S17 the second magnetic layer 6 on the first magnetic layer 5 formed on the substrate 1, and progresses the process to step S18. A magnetic domain structure of the first magnetic layer 5 is transferred on the second magnetic layer 6 by exchange coupling.

The controller cools the substrate 1 in the step S18, and progresses the process to step S19. The controller forms in the step S19 the overcoat layer 7 on the second magnetic layer 6 formed on the substrate 1, and progresses the process to step S20. The controller unloads the substrate 1 in the step S20, and terminates the process flow.

As explained above, the manufacturing apparatus 20A of this embodiment performs demagnetization with the substrate temperature being high, i.e., with the coercivity of the first magnetic layer 5 being reduced by heating the substrate 1. Accordingly, it becomes possible to perform demagnetization by applying smaller magnetic fields, and thus the first magnetic layer 5 can be easily demagnetized which has a high coercivity.

Moreover, according to this embodiment, in order to enhance the magnetic anisotropy, the heated substrate 1 is cooled before the first magnetic layer 5 is deposited, and demagnetization is performed before the coercivity of the first magnetic layer 5 becomes high. Accordingly, it becomes unnecessary to additionally provide heating means for demagnetization, and thus demagnetization is facilitated while avoiding the increase in size of the apparatus structure.

### Modified Example

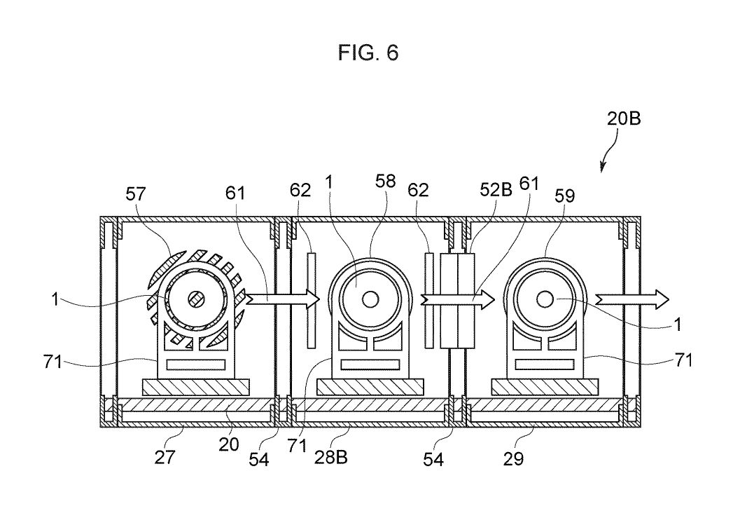

Next, an explanation will be given of a modified example of the manufacturing apparatus of this embodiment with reference to FIG. 6. The same structure as that of the first embodiment will be denoted by the same reference numeral, and the explanation thereof will be omitted. A manufacturing apparatus of this modified example differs from the first embodiment that the magnetic field generator is provided between the first-magnetic-layer formation chamber and the second-magnetic-layer formation chamber 29. The explanation will be continued with reference to FIG. 6 that corresponds to FIG. 4.

As illustrated in this figure, a manufacturing apparatus 20B includes the heating chamber 27, a first-magnetic-layer formation chamber 28B, and the second-magnetic-layer formation chamber 29, and the respective chambers are partitioned by the partition walls 54. The first-magnetic-layer formation chamber 28B is provided with a first target 58. According to this modified example, a magnetic field generator 52B is provided at the partition wall 54 that partitions the first-magnetic-layer formation chamber 28B and the second-magnetic-layer formation chamber 29, not in the first-magnetic-layer formation chamber 28B.

The magnetic field generator 52B includes permanent magnets provided at both sides of the substrate 1 so that the transported substrate 1 is present therebetween. The permanent magnet has magnetic poles disposed so as to generate parallel in-plane magnetic fields to the surfaces of the substrate 1. The magnetic field generator 52B is provided outside the process environment so as not to affect the plasma during the deposition in the first-magnetic-layer formation chamber 28B and the second-magnetic-layer formation chamber 29. According to this modified example, the magnetic field generator 52B is provided at a location distant from the first-magnetic-layer formation chamber 28B and the second-magnetic-layer formation chamber 29 in such a way that the magnetic fields generated by the magnetic field generator 52B to the substrate 1 during the deposition in the respective chambers becomes equal to or smaller than 30 G.

The first-magnetic-layer formation chamber 28B is provided with a compact irradiation heater 62 as a heater. The substrate 1 is auxiliary heated by the irradiation heater 62 while being transported from the heating chamber 27 to the first-magnetic-layer formation chamber 28B, and while being transported from the first-magnetic-layer formation chamber 28B to the second-magnetic-layer formation chamber 29.

Next, an explanation will be given of an operation of the manufacturing apparatus employing the above-explained structure according to the modified example. The controller transports the substrate 1 heated in the heating chamber 27 to the first-magnetic-layer formation chamber 28B. The substrate 1 is auxiliary heated by the irradiation heater 62 provided at the first-magnetic-layer formation chamber 28B while being transported. The controller forms, in the first-magnetic-layer formation chamber 28B, the first magnetic layer 5 on the orientation layer 4 formed on the substrate 1.

Next, the controller transports the substrate 1 to the second-magnetic-layer formation chamber 29. The substrate 1 is auxiliary heated by the irradiation heater 62 provided at the first-magnetic-layer formation chamber 28B, while being transported, and passes through the magnetic field generator 52B. In-plane magnetic fields are applied to the surface of the substrate 1 while the substrate is being transported, and thus the first magnetic layer 5 is demagnetized.

The manufacturing apparatus of the modified example performs demagnetization with the coercivity of the first magnetic layer being reduced by heating the substrate 1 as explained above, and thus the same advantages as those of the first embodiment can be accomplished.

According to this modified example, auxiliary heating is performed by the irradiation heater 62 provided at the first-magnetic-layer formation chamber 28B, and thus the temperature drop of the substrate 1 due to heat irradiation can be suppressed during the deposition of the first magnetic layer 5 and the transporting. Hence, it becomes possible to apply in-plane magnetic fields to the first magnetic layer 5 with a further higher temperature being maintained, and thus the first magnetic layer 5 can be demagnetized with further smaller magnetic fields.

According to this modified example, the explanation was given of the case in which the magnetic field generator 52B is provided at a location sufficiently apart from the first-magnetic-layer formation chamber 28B and the second-magnetic-field generation chamber 29 so as not to affect the plasma during the deposition in the first-magnetic-layer formation chamber 28B and the second-magnetic-layer formation chamber 29, but the present invention is not limited to this case.

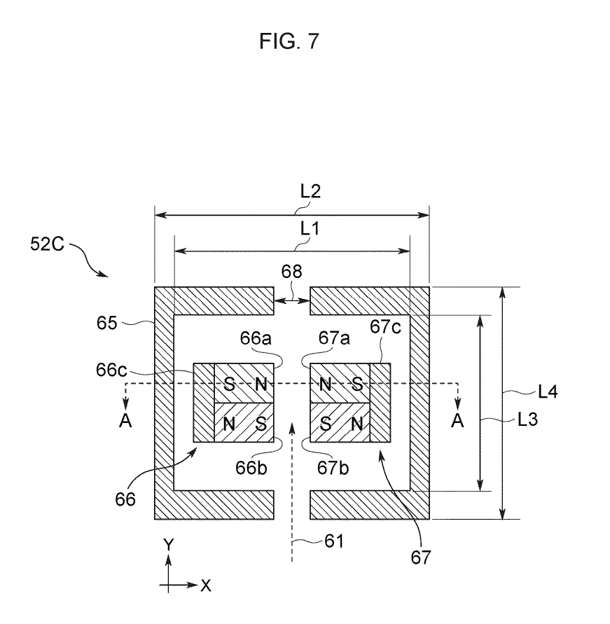

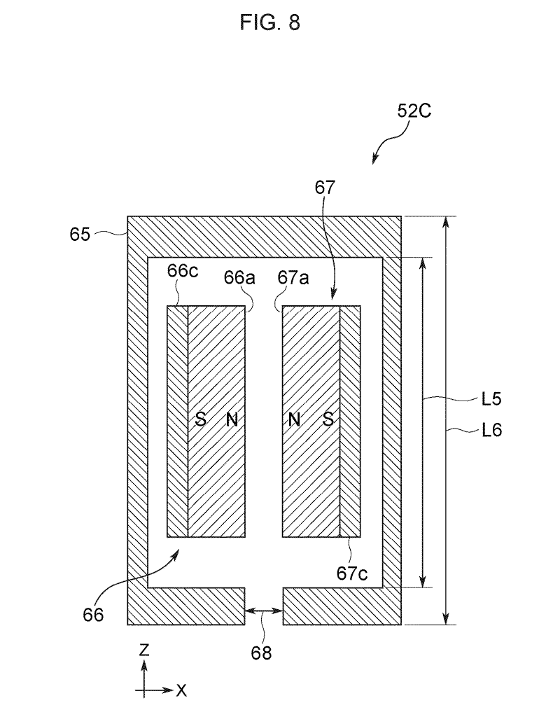

For example, as illustrated in FIGS. 7 and 8, a magnetic field generator 52C may be constructed by a magnetic-field permeable housing 65, and permanent magnet assemblies 66 and 67 provided in the magnetic-field permeable housing 65.

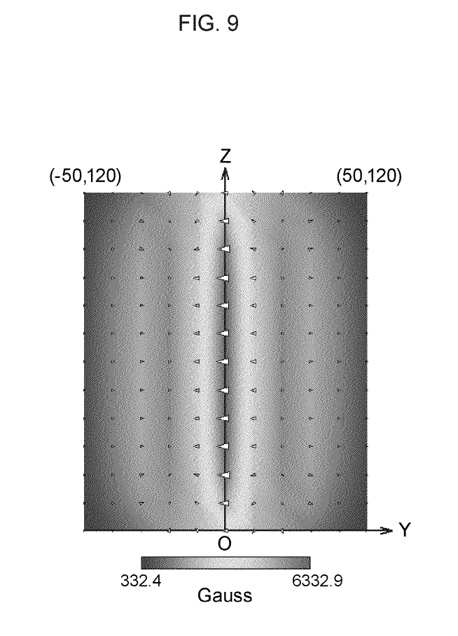

The magnetic-field permeable housing 65 is a member in a box shape having a passage 68 which is formed in the pair of side faces on the bottom face and through which the substrate 1 held on the carrier 71 passes. The permanent magnet assemblies 66 and 67 include a pair of yoke plates 66c and 67c provided in the magnetic-field permeable housing 65 across the passage 68, and a plurality of (in this figure, two for each and four at total) permanent magnets 66a, 66b, and 67a, 67b held by the respective yoke plates 66c and 67c. The permanent magnets 66a, 66b, and 67a, 67b are disposed in such a way that the different polarities are in parallel with each other so as to generate in-plane magnetic fields parallel to the surface of the substrate 1 passing through the passage 68. The permanent magnet assemblies 66 and 67 are provided symmetrically across the passage 68 so as to maximize the magnetic fields between the permanent magnet assemblies 66 and 67. The generated magnetic fields are parallel to surfaces (Y-Z planes) of the permanent magnet assemblies 66 and 67 facing with each other, and are parallel to a transporting direction 61 of the substrate 1. As illustrated in FIG. 9, the magnetic fields generated by the magnetic field generator 52C have the intensity becoming the maximum (substantially 6000 G) at the substantial center of the permanent magnet, and have the direction parallel to the Y-Z direction.

Regarding the magnetic-field permeable housing 65, for example, respective sizes of the components can be set as follows: the width of the passage 68 is 20 mm; L1 is 120 mm; L2 is 140 mm; L3 is 90 mm; L4 is 120 mm; L5 is 170 mm; and L6 is 210 mm. The magnetic-field permeable housing 65 efficiently absorbs the magnetic fields generated by the permanent magnet assemblies 66 and 67, thereby suppressing the magnetic fields leaked to the exterior of the magnetic-field permeable housing 65 at minimum.

### (3) Second Embodiment

Next, an explanation will be given of a manufacturing apparatus according to a second embodiment. The same component as that of the first embodiment will be denoted by the same reference numeral, and the explanation thereof will be omitted. The manufacturing apparatus of this embodiment differs from the first embodiment that such a manufacturing apparatus is provided with a demagnetization heating chamber 42A.

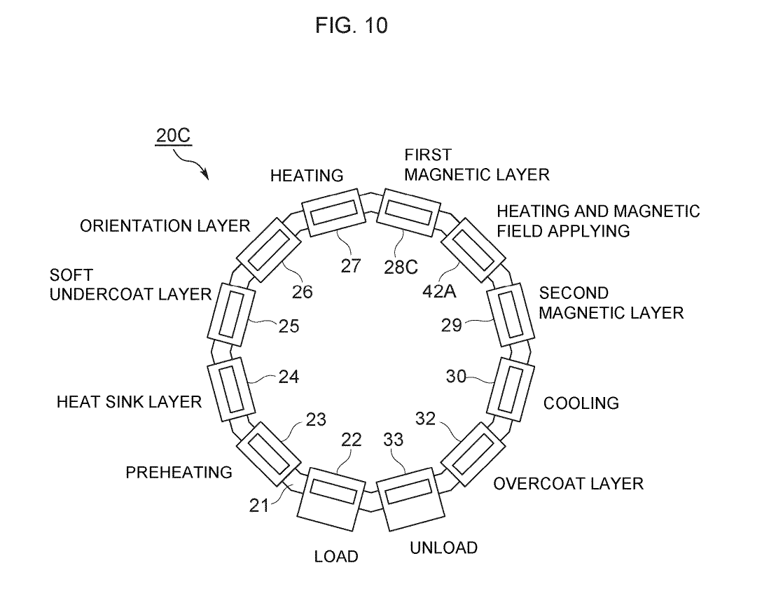

A manufacturing apparatus 20C illustrated in FIG. 10 includes the transfer system 21, the load lock chamber 22, the preheating chamber 23, the heat-sink-layer formation chamber 24, the soft-magnetism-undercoat-layer formation chamber 25, the orientation-layer formation chamber 26, the heating chamber 27, a first-magnetic-layer formation chamber 28C, the demagnetization heating chamber 42A, the second-magnetic-layer formation chamber 29, the first cooling chamber 30, the overcoat-layer formation chamber 32, and the unload chamber 33, and is capable of manufacturing the perpendicular magnetic recording medium 11 having multilayer films on both sides of the substrate 1.

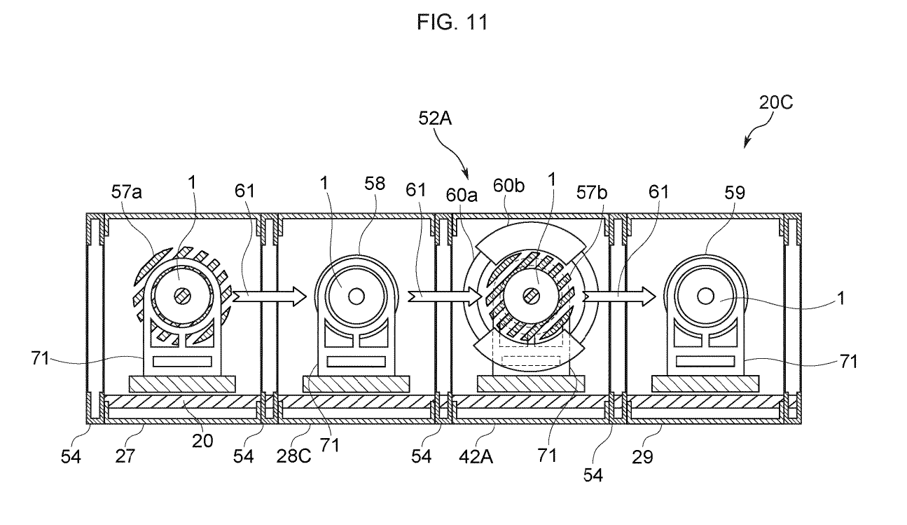

FIG. 11 is a vertical cross-sectional view illustrating the heating chamber 27, the first-magnetic-layer formation chamber 28C, the demagnetization heating chamber 42A, and the second-magnetic-layer formation chamber 29 that are some of the chambers constructing the manufacturing apparatus 20C. The respective chambers are partitioned by partition walls 54. In practice, the partition wall 54 is provided with an unillustrated gate valve, and is formed so as to prevent the process gas from going in and out between the respective chambers.

As illustrated in this figure, the heating chamber 27 includes a plurality of first irradiation heaters 57a provided at both sides of the substrate 1 with the substrate 1 being present therebetween. The first-magnetic-layer formation chamber 28C includes the first targets 58 provided at both sides of the substrate 1 with the substrate 1 being present therebetween. The second-magnetic-layer formation chamber 29 has the second targets 59 provided at both sides of the substrate 1 with the substrate 1 being present therebetween.

The demagnetization heating chamber 42A has a plurality of second irradiation heaters 57b and the magnetic field generator 52A provided at both sides of the substrate 1 with the substrate 1 being present therebetween. Accordingly, the demagnetization heating chamber 42A heats the substrate 1, while at the same time, applies in-plane magnetic fields to the substrate 1.

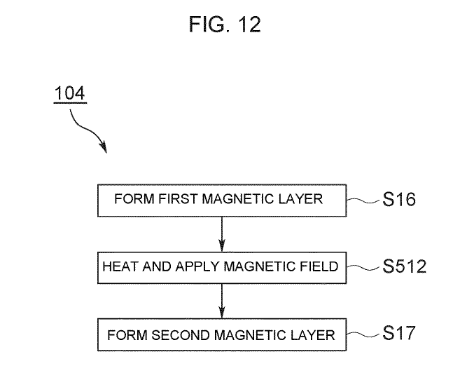

Next, an explanation will be given of only characteristic part of the process flow by the manufacturing apparatus of this embodiment with reference to FIG. 12. That is, a process flow 104 corresponding to the steps S16 to S17 in FIG. 5 will be explained.

The controller forms in step SP16 the first magnetic layer 5 on the orientation layer 4 formed on the substrate 1, and progresses the process to step S512.

The controller heats the substrate 1, while at the same time, applies in-plane magnetic fields to the substrate 1 in the step S512. By heating the substrate 1 and applying the in-plane magnetic fields to the substrate 1 simultaneously, the substrate 1 can be surely heated again to a predetermined temperature, e.g., a temperature near the Curie temperature regardless of the temperature drop of the substrate 1 by heat irradiation during the deposition of the first magnetic layer 5 and the transporting. Hence, the in-plane magnetic fields can be applied to the first magnetic layer 5 with the substrate 1 being surely maintained at a high temperature, and thus the first magnetic layer 5 can be demagnetized with smaller magnetic fields.

Next, the controller progresses the process to step S17. The controller forms in the step S17 the second magnetic layer 6 on the first magnetic layer 5 formed on the substrate 1, and progresses the process to next step.

As explained above, the manufacturing apparatus 20C of this embodiment performs demagnetization with the temperature of the substrate being high, i.e., the coercivity of the first magnetic layer being reduced by heating the substrate 1, thereby accomplishing the same advantages as those of the first embodiment.

### Modified Example

Next, an explanation will be given of a modified example of the manufacturing apparatus according to this embodiment. The same component as that of the second embodiment will be denoted by the same reference numeral, and the explanation thereof will be omitted. The manufacturing apparatus of this modified example differs from the second embodiment that a magnetic field generator is provided between the demagnetization heating chamber and the second-magnetic-layer formation chamber 29.

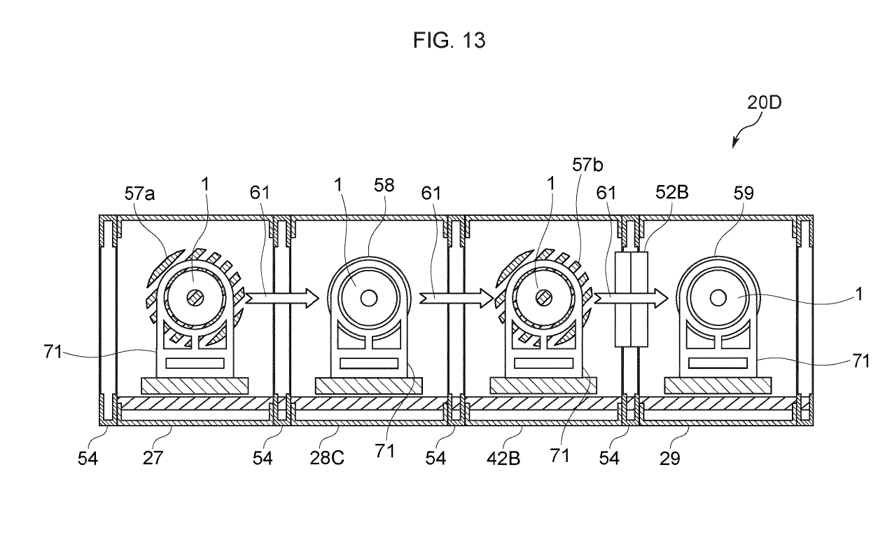

As illustrated in FIG. 13, a manufacturing apparatus 20D includes the heating chamber 27, the first-magnetic-layer formation chamber 28C, a demagnetization heating chamber 42B, and the second-magnetic-layer formation chamber 29, and the respective chambers are partitioned by the partition walls 54. The demagnetization heating chamber 42B is provided with the second irradiation heater 57b. According to this modified example, the magnetic field generator 52B is provided at the partition wall 54 that partitions the demagnetization heating chamber 42B and the second-magnetic-layer formation chamber 29, not in the demagnetization heating chamber 42B.

The magnetic field generator 52B includes permanent magnets provided at both sides of the substrate 1 with the transported substrate 1 being present therebetween. The magnetic field generator 52B of this modified example is the same as the magnetic field generator 52B explained with reference to FIG. 6, and thus the detailed explanation thereof will be omitted.

Next, an explanation will be given of an operation of the manufacturing apparatus 20D employing the above-explained structure according to this modified example. The controller transports the substrate 1 heated by the heating chamber 27 to the first-magnetic-layer formation chamber 28C. The controller forms, in the first-magnetic-layer formation chamber 28C, the first magnetic layer 5 on the orientation layer 4 formed on the substrate 1.

Subsequently, the controller heats the substrate 1. Accordingly, the substrate 1 can be surely heated again to a predetermined temperature, e.g., a temperature near the Curie temperature regardless of the temperature drop of the substrate 1 due to heat irradiation during the deposition of the first magnetic layer 5, and the transporting.

Next, the controller transports the substrate 1 to the second-magnetic-layer formation chamber 29. The substrate 1 passes through the magnetic field generator 52B while being transported. During the transporting, in-plane magnetic fields are applied to the surface of the substrate 1, and thus the first magnetic layer 5 is demagnetized. Since the substrate 1 is heated again, the first magnetic layer 5 can be demagnetized with smaller magnetic fields.

Subsequently, the controller transports the substrate 1 to the second-magnetic-layer formation chamber 29, and forms the second magnetic layer 6 on the first magnetic layer 5 formed on the substrate 1.

As explained above, the manufacturing apparatus 20D of this modified example performs demagnetization with the coercivity of the first magnetic layer 5 being reduced by heating the substrate 1, and thus the same advantages as those of the second embodiment can be accomplished.

### Another Modified Example

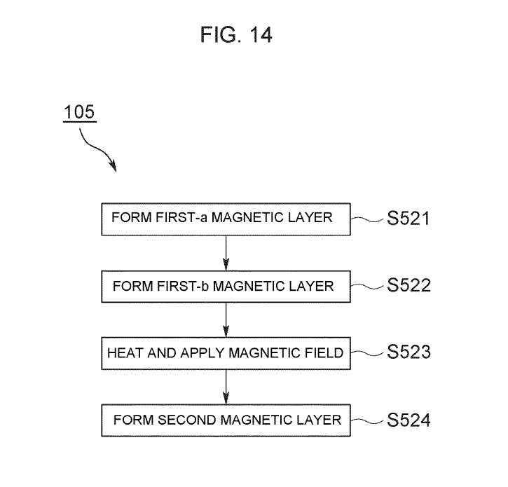

Next, another modified example of the manufacturing apparatus of this embodiment will be explained. The same component as that of the second embodiment will be denoted by the same reference numeral, and the explanation thereof will be omitted. This modified example has the process flow corresponding to the step S512 in FIG. 12 different from that of the second embodiment. An explanation will be below given of a process flow 105 corresponding to the step S512 in FIG. 12 with reference to FIG. 14.

As illustrated in this figure, the controller forms in step S521 a first-a magnetic layer on the orientation layer 4 formed on the substrate 1, and progresses the process to step S522. The first-a magnetic layer is an undercoat layer of a first-b magnetic layer to be formed. Next, the controller forms in the step S522 the first-b magnetic layer on the first-a magnetic layer formed on the substrate 1, and progresses the process to step S523. In the step S523, the controller heats the substrate 1, while at the same time, applies in-plane magnetic fields to the substrate 1, and progresses the process to step S524. The controller forms in the step S17 the second magnetic layer on the first magnetic layer formed on the substrate 1, and progresses the process to next step. The second magnetic layer is formed of a material having a smaller coercivity than those of the first-a magnetic layer and the first-b magnetic layer.

As explained above, the manufacturing apparatus of this modified example performs demagnetization with the coercivity of the first magnetic layer being reduced by heating the substrate 1, and thus the same advantages as those of the second embodiment can be accomplished.

Moreover, according to this modified example, the first magnetic layer 5 having the maximum coercivity is deposited as the two layers that are the first-a magnetic layer and the first-b magnetic layer. But by forming the second magnetic layer having the smaller coercivity than that of the first magnetic layer 5, the coercivity of the whole medium can be reduced. Accordingly, the magnetic fields applied for demagnetization can be reduced.

### (4) Third Embodiment

Next, an explanation will be given of a manufacturing apparatus according to a third embodiment. The same component as that of the first embodiment will be denoted by the same reference numeral, and the explanation thereof will be omitted. The manufacturing apparatus of this embodiment differs from the first embodiment that the magnetic field generator is a magnet unit for sputtering provided in the first-magnetic-layer formation chamber 28C.

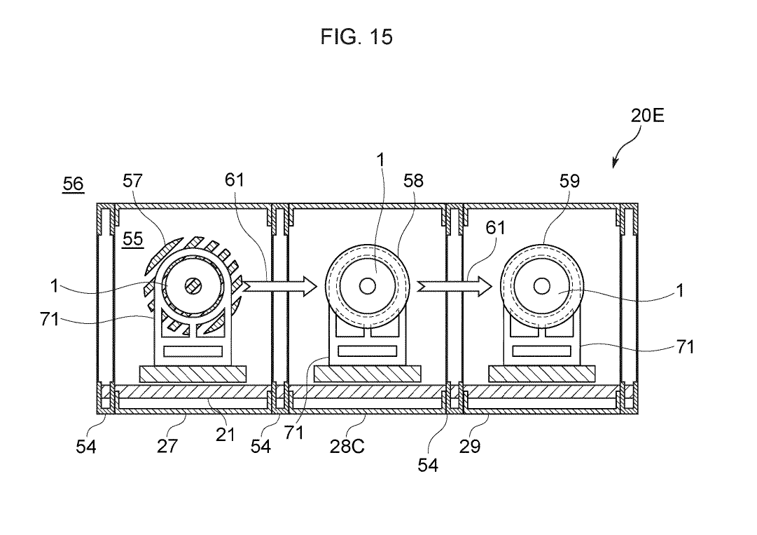

As illustrated in FIG. 15, a manufacturing apparatus 20E includes the heating chamber 27, the first-magnetic-layer formation chamber 28C, and the second-magnetic-layer formation chamber 29. The manufacturing apparatus 20E differs from the first embodiment that no magnetic field generator is separately provided like the above-explained embodiment.

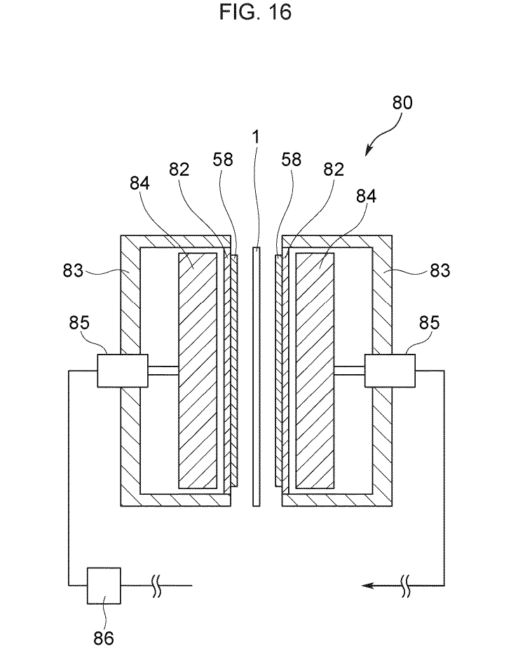

As illustrated in FIG. 16, the first magnetic-layer-formation chamber 28C has the pair of first targets 58 provided at both sides of the substrate 1 with the substrate 1 being present therebetween. The structures at both sides of the substrate 1 are the same, and thus only one-sided structure will be explained for simplification of the explanation. The first target 58 is fastened to a target holder 82 provided on a back face. The target holder 82 is provided at a cathode main body 83.

Magnet units 84 are provided in the cathode main body 83. The magnet units 84 also serve as a magnetic field generator 80. That is, the magnetic field generator 80 includes the magnet units 84, a drive unit 85 that rotates the magnet units 84, and a control unit 86 that controls the rotation operation of the drive unit 85.

The control unit 86 rotates the pair of magnet units 84 during the deposition so as to improve the availability of the first target 58 and the film thickness uniformity. In this case, the pair of magnet units 84 may be rotated in a condition in which the magnetic polarities are synchronized or not synchronized during the deposition.

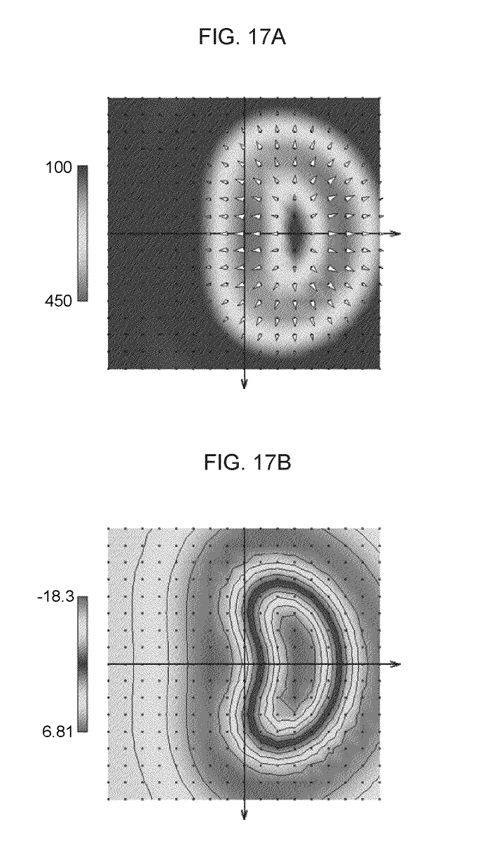

Next, the control unit stops rotations of the pair of magnet units 84 with the magnetic polarities being synchronized after the deposition of the first magnetic layer 5 completes. Accordingly, the magnet units 84 generate in-plane magnetic fields parallel to the surface of the substrate 1. The in-plane magnetic fields has the maximum magnetic field (450 [Oe]) that is parallel to the surface of the substrate 1 along the transporting direction of the substrate 1 (see FIG. 17A), and has the minimum magnetic field that is perpendicular to the surface of the substrate 1 (see FIG. 17B). The magnetic field maps of FIGS. 17A and 17B are areas across 80 mm by 80 mm from the center position of the substrate 1 during the deposition.

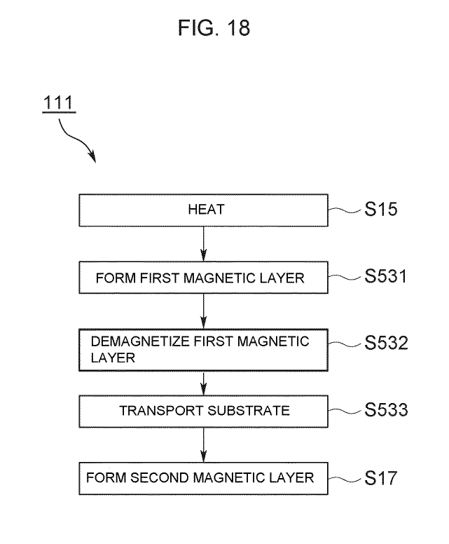

Next, an explanation will be given of only a characteristic part of the process flow by the manufacturing apparatus of this embodiment with reference to FIG. 18. That is, an explanation will be given of a process flow 111 corresponding to the steps S15 to S17 in FIG. 5.

The controller heats the substrate 1 to a temperature of equal to or higher than 400° C. in the step S15, and progresses the process to step S531. The controller forms in the step S531 the first magnetic layer 5 on the orientation layer 4 formed on the substrate 1, and progresses the process to step S532.

In the step S532, the controller stops the pair of magnet units 84 in a synchronized condition to apply in-plane magnetic fields to the substrate 1. In this case, magnetic fields generated by the magnet units are small that is 450 [Oe] or so, but the magnetic fields can be applied right after the deposition and before the substrate 1 is transported. Hence, according to this embodiment, demagnetization is performed at a substrate temperature that is near the Curie temperature, and thus demagnetization can be performed with relatively small magnetic fields. Next, the controller progresses the process to step S533, transports the substrate 1 to the second-magnetic-layer formation chamber 29, and progresses the process to the step S17.

The controller forms in the step S17 the second magnetic layer 6 on the first magnetic layer 5 formed on the substrate 1, and progresses the process to next step.

As explained above, the manufacturing apparatus 20E of this embodiment performs demagnetization with the coercivity of the first magnetic layer 5 being reduced by heating the substrate 1, and thus the same advantages as those of the first embodiment can be accomplished.

### Modified Example

The present invention is not limited to the above-explained embodiments, and can be changed and modified in various forms within the scope of the present invention. For example, in the above-explained embodiments, the explanation was given of the example case in which the perpendicular magnetic recording medium has multilayer films formed on both sides of the substrate, but the present invention is not limited to this case. A multilayer film may be formed on either one side of the substrate.

Moreover, according to the above-explained embodiments, the explanation was given of the example case in which the perpendicular magnetic recording medium includes the first and second magnetic layers, but the present invention is not limited to this case. The perpendicular magnetic recording medium may include only the first magnetic layer.

What is claimed is:

1. A method of manufacturing a demagnetized perpendicular magnetic recording medium comprising:
forming a magnetic layer on a substrate;
applying a magnetic field parallel to a surface of the magnetic layer having a coercivity reduced below the intensity of said magnetic field by heating of the magnetic layer; and
removing said magnetic field.

2. The perpendicular magnetic recording medium manufacturing method according to claim 1, further comprising:
heating the substrate before forming the magnetic layer.

3. The perpendicular magnetic recording medium manufacturing method according to claim 1, further comprising:
heating the magnetic layer after forming the magnetic layer and before applying the magnetic field.

4. The perpendicular magnetic recording medium manufacturing method according to claim 1, wherein the magnetic field is applied parallel to the surface of the magnetic layer while heating the magnetic layer.

5. The perpendicular magnetic recording medium manufacturing method according to claim 1, wherein the magnetic layer comprises a high magnetic anisotropy material.

6. The perpendicular magnetic recording medium manufacturing method according to claim 3, wherein the heating of the magnetic layer comprises:
heating the magnetic layer to a temperature lower and within 100° C. of the Curie temperature of the magnetic layer.

7. A method of manufacturing a demagnetized perpendicular magnetic recording medium comprising:
forming a first magnetic layer on a substrate;
applying a magnetic field parallel to a surface of the first magnetic layer having a coercivity reduced below the intensity of said magnetic field by heating of the first magnetic layer;
removing the magnetic field; and
forming a second magnetic layer having a coercivity less than the first magnetic layer coercivity on the first magnetic layer.

8. The perpendicular magnetic recording medium manufacturing method according to claim 7, further comprising:
heating the substrate before forming the first magnetic layer.

9. The perpendicular magnetic recording medium manufacturing method according to claim 7, further comprising:
heating the first magnetic layer after forming the first magnetic layer and before applying the magnetic field.

10. The perpendicular magnetic recording medium manufacturing method according to claim 7, wherein the magnetic field is applied parallel to the surface of the first magnetic layer while heating the first magnetic layer.

11. An apparatus for manufacturing a perpendicular magnetic recording medium, the apparatus comprising:
a heating chamber that heats a substrate;
a first-magnetic-layer formation chamber that forms a first magnetic layer on the substrate; and
a magnetic field generator that applies, to the substrate on which the first magnetic layer is formed, a magnetic field parallel to a surface of the substrate.

12. The perpendicular magnetic recording medium manufacturing apparatus according to claim 11, wherein the magnetic field generator is provided in the first-magnetic-layer formation chamber.

13. The perpendicular magnetic recording medium manufacturing apparatus according to claim 11, further comprising:
a second-magnetic-layer formation chamber that forms a second magnetic layer on the first magnetic layer; and
a transfer system that transports the substrate from the first-magnetic-layer formation chamber to the second-magnetic-layer formation chamber, wherein the magnetic field generator applies, to the substrate being transported from the first-magnetic-layer formation chamber to the second-magnetic-layer formation chamber, the magnetic field parallel to the surface of the substrate.

14. The perpendicular magnetic recording medium manufacturing apparatus according to claim 11, further comprising:
a second-magnetic-layer formation chamber that forms a second magnetic layer on the first magnetic layer; and
a demagnetization heating chamber provided between the first-magnetic-layer formation chamber and the second-magnetic-layer formation chamber, wherein the magnetic field generator is provided in the demagnetization heating chamber.

15. The perpendicular magnetic recording medium manufacturing apparatus according to claim 11, further comprising:
a second-magnetic-layer formation chamber that forms a second magnetic layer on the first magnetic layer;
a heating chamber provided between the first-magnetic-layer formation chamber and the second-magnetic-layer formation chamber; and
a transfer system that transports the substrate to the first-magnetic-layer formation chamber, the heating chamber, and the second-magnetic-layer formation chamber in this order, wherein the magnetic field generator applies, to the substrate being transported from the heating chamber to the second-magnetic-layer formation chamber, the magnetic field parallel to the surface of the substrate.

16. The perpendicular magnetic recording medium manufacturing apparatus according to claim 13, wherein the magnetic field generator is provided with a distance from the first-magnetic-layer formation chamber and the second-magnetic-layer formation chamber in such a way that the generated magnetic field does not affect sputtering.

17. The perpendicular magnetic recording medium manufacturing apparatus according to claim 13, wherein the magnetic field generator is provided in a magnetic-field permeable housing disposed between the first-magnetic-layer formation chamber and the second-magnetic-layer formation chamber.

18. The perpendicular magnetic recording medium manufacturing apparatus according to claim 12, wherein the magnetic field generator is an electro magnet.

19. The perpendicular magnetic recording medium manufacturing apparatus according to claim 16, wherein the magnetic field generator is a permanent magnet.

20. The perpendicular magnetic recording medium manufacturing apparatus according to claim 13, wherein a heater is provided in the first-magnetic-layer formation chamber.

21. The perpendicular magnetic recording medium manufacturing apparatus according to claim 13, wherein the first-magnetic-layer formation chamber and the second-magnetic-layer formation chamber form the first magnetic layers and the second magnetic layers on both sides of the substrate.

22. An apparatus for manufacturing a perpendicular magnetic recording medium, the apparatus comprising:
a heating chamber that heats a substrate;
a first-magnetic-layer formation chamber that forms a first magnetic layer on the substrate;
a second-magnetic-layer formation chamber that forms a second magnetic layer on the first magnetic layer; and
a transfer system that transports the substrate from the first-magnetic-layer formation chamber to the second-magnetic-layer formation chamber,
the first-magnetic-layer formation chamber comprising a pair of magnet units provided on either side of the substrate in a freely rotatable manner, and
the apparatus further comprising a controller that stops rotations of the pair of magnet units with magnetic polarities being synchronized with each other.
